(19) United States
(12) Patent Application Publication
(10) Pub. No.: US 2002/0002033 A1
(43) Pub. Date: Jan. 3, 2002

(54) SATELLITE DELIVERED TEXT

(76) Inventor: STANLEY G. ROSEN, LOS ANGELES, CA (US)

Correspondence Address: JOHN A. ARTZ, ESQ., ARTZ & ARTZ, 28333 TELEGRAPH ROAD, SUITE 250, SOUTHFIELD, MI, 48034, US

(21) Appl. No.: 09/285,423

(22) Filed: Apr. 2, 1999

(51) Int. Cl. H04B 7/185; H04Q 7/20; H04M 1/00; H04B 1/38

(52) U.S. Cl. 455/12.1; 455/427

(57) ABSTRACT

An electronic communications device that electronically stores and displays several pages of text and graphics having the capability to be updated by satellite communication thereby enabling a large number of devices to be updated over a wide coverage area. Satellites having low data transmission rates may be used thereby enabling cost effective satellite communications and promoting widespread use of the electronic communications device.

### TECHNICAL FIELD

The present invention relates to personal communication devices, and more particularly, to a method for updating information supplied to personal communication devices using satellite systems.

### BACKGROUND ART

There is widespread use of handheld personal communication devices. Such devices are small, inexpensive display terminals such as pagers and mobile telephones that communicate by way of local wireless communication methods and typically handle a relatively small amount of data for display, i.e. a message of only a few lines and/or paging applications. In other words, the amount of data that can be received is very limited.

Electronic books have the capability to store and display the text of entire books. In current practices, updating the text of an electronic book requires physical memory replacement, i.e. memory cartridges or direct physical connection with a data source.

Current personal communication devices are not capable of receiving a large volume of text such as a textbook or a novel. Local wireless communication methods are applicable to only a small area and are expensive to implement over a wide area. High data rate communication devices that have satellite capabilities require high gain satellite antennas that must be precisely pointed at the satellite and require complex, high cost receivers. These terminals are relatively expensive thereby not conducive to widespread use.

### SUMMARY OF THE INVENTION

The present invention is an electronic communication device that stores and displays several pages of textual or simple graphic material. The electronic device has the capability to affordably communicate with a geostationary or non-geostationary satellite system in order to update the contents of the electronic communication device. With the present invention, a large number of devices can be updated over a large area. The low-cost terminal facilitates widespread use. The satellite system allows communication over a very large area, as opposed to local cellular service. The personal communication device of the present invention will allow widescale updating of a large number of low cost electronic storage and display devices.

The device of the present invention includes a storage/display device that communicates with an orbiting element. The electronic data storage and display device has an omni-directional antenna and is capable of communicating with the orbiting element. The orbiting element includes a satellite or a series of satellites that communicate directly with the storage/display device at low to moderate data rates. The speed of the data delivery rate is not critical. For example, the entire text can be transmitted overnight to the device that is ready for use with updated text in the morning.

The device of the present invention is a communication device having satellite communication capability for allowing a relatively large amount of textual data to be updated over a period of time. The personal communication device need not be limited to handheld devices and may be a large, stationary earth bound object, i.e. an electronic billboard. The widescale updating of a large number of low cost electronic storage and display devices could be used for manuals, textbooks, newsletters, electronic newspapers, billboards, etc.

It is an object of the present invention to provide a communication device that is capable of receiving a relatively large amount of textual data from a satellite system. It is another object of the present invention to provide the updated text service by a satellite system that may have a relatively low data delivery rate, thereby providing updated text without expensive satellite communication costs.

It is still another object of the present invention to update a large number of electronic communication devices either simultaneously or as desired.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagram of the device and satellite system of the present invention;

FIG. 2 is a block diagram of a satellite system used in conjunction with the device of the present invention; and

FIG. 3 is a block diagram of another satellite system used in conjunction with the device of the present invention.

### BEST MODES FOR CARRYING OUT THE INVENTION

Referring to FIG. 1, there is shown an electronic communication device 10 of the present invention used in conjunction with a satellite system 12. The device 10 electronically stores and displays several (i.e., tens to hundreds) pages of textual and/or graphic material. The electronic device 10 may have transmit and receive capabilities for communication with a satellite system 12 or may be only a receiver.

The electronic device 10 can take many forms. For example, it could be similar to an electronic book, but have the additional feature of satellite communication. Such a device is a touch screen having a high resolution, liquid crystal display.

The electronic communication device 10 must also have a micro-processor, data storage capability and a telecommunications module. The telecommunications module can be an integral element of the overall device, for efficient packaging, operational simplicity and overall convenience.

Internal data storage of the device allows data to be downlinked and accessed by the user at appropriate and convenient times. Information can be communicated to the device and accessed by a user anywhere and at any time.

The satellite system 12 is comprised of one or more satellites in geostationary or non-geostationary orbit. The satellite system 12 also includes control and data uplink equipment 14.

The satellite system 12 communicates directly with the electronic communication device 10. Due to the nature of the text that is being updated to the electronic communication device 10, low to moderate data rates, (i.e., <<100 kbps), are acceptable. The satellite system 12 can be a system already in operation that has the power level and capacity to handle the added traffic for updating the electronic communication devices 10, or it could be a dedicated satellite system 12. In either scenario, the data rate can be lower than many other satellite applications require, because instantaneous data delivery is not required, such as for voice, television, or radio communications. All that is required from satellites that are already in orbit is enough power for a reasonable data rate.

It may be beneficial to tailor a satellite system in order to optimize service beam directions. For example if a particular group of users is to be targeted.

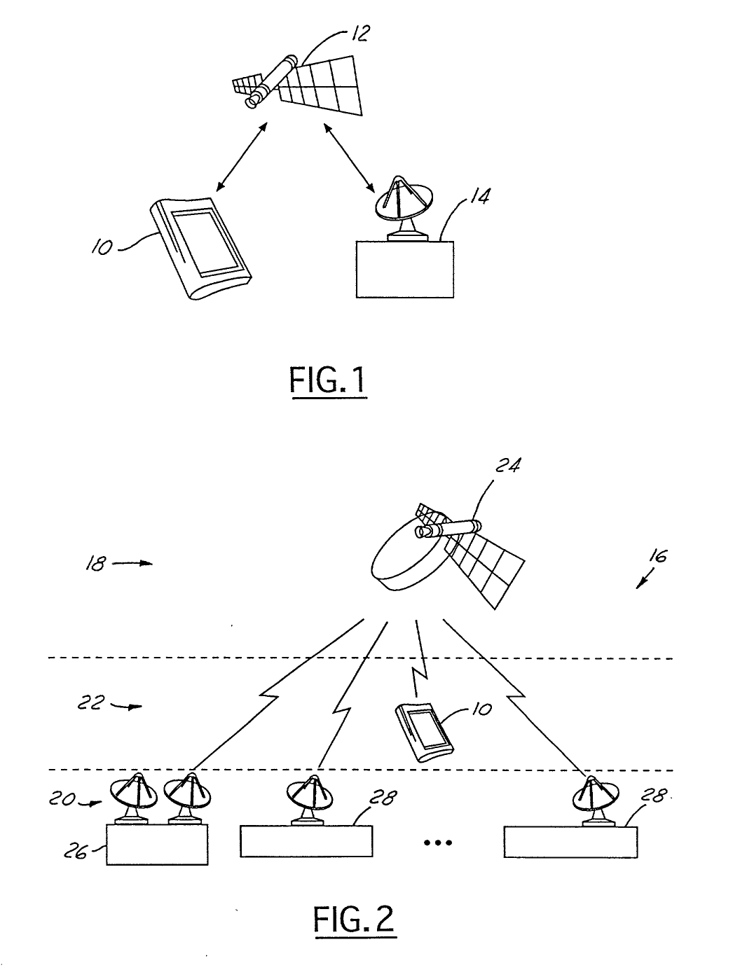

In any event, a cost effective high-quality satellite system is necessary for widespread acceptance of the present invention. One example of a satellite system is a geo-stationary satellite system 16, shown in FIG. 2. This system 16 has a space segment 18 and a ground segment 20 used in conjunction with a user segment 22, which is the electronic communication device 10 of the present invention. The space segment 18 consists of at least one satellite 24 which may have an onboard digital signal processor (not shown).

The ground segment 20 has a primary gateway 26 and one or more secondary gateways and uplink stations 28. The primary gateway 26 provides overall control of the satellite 24. The secondary gateways 28 provide area coverage and communication with one or more electronic communication devices 10 of the present invention. The secondary gateways and uplink stations 28 transmit special signals that are tracked by the satellite 24 to maintain precise pointing of its beams.

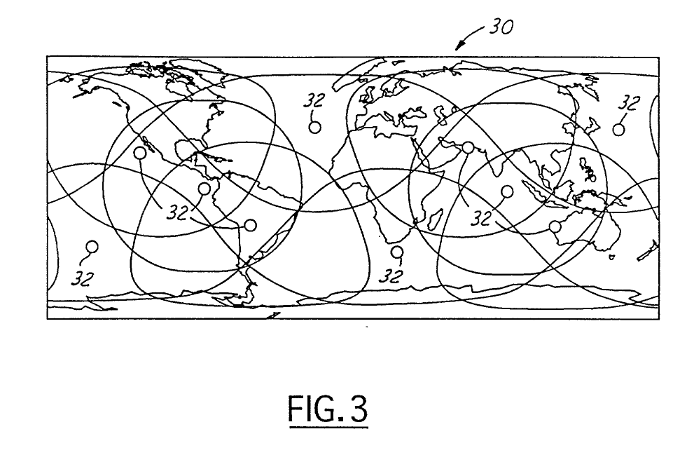

Another possible satellite system that can be used in conjunction with the device 10 of the present invention is the non-geostationary satellite system 30, which is a global satellite based communications system shown in FIG. 3. This system 30 includes a constellation of satellites having coverage patterns designed for significant overlap. This ensures that at least two, but sometimes three or four, satellites are in view of a user at any time. The satellite orbits have been selected to provide continuous coverage of most of the globe.

Independent of the satellite system employed, control and data uplink stations 14, shown in FIG. 1, are required. The control and data uplink stations 14 would include one or more ground stations for communicating with the satellite system 12. The control and data uplink equipment 14 maintains each satellite's 12 operational condition, such as orbit position, health status, and overall functionality. The control and data uplink equipment 14 also sends commands to each satellite 12 for controlling the dissemination of data streams transmitted from the ground station.

The uplink stations 14 receive information from various originating organizations, as well as instructions as to whom the information is to be delivered, timing of delivery, delivery confirmation instructions, etc. The information is then sent to the appropriate satellite 12 at the proper time to ensure delivery to the electronic communication device 10 and ultimately to the end user, or subscriber.

Slow to moderate data transmission rates are a limitation associated with some types of affordable satellite communication. However, due to the nature of the data being utilized by the electronic communication device 10 of the present invention, this is not a significant sacrifice. Real time data access is not important. Therefore, a user can order data by direct communication with a service provider through satellite communication, or by other methods, i.e. Internet, phone, etc. For satellite communication, it is possible to equip the device with limited uplink capabilities for sending short messages to be received by the satellite.

The potential applications of the present invention are limitless and impossible to describe adequately herein. Some example applications include updating manuals, textbooks, newsletters, billboards, etc. Instructors can update course material every night if desired. Additionally, a limitless electronic book library is accessible anywhere and at any time without having to replace memory cartridges or experience limited accessibility restricted by the availability of a phone line. Additionally, the present invention is capable of updating large volumes of text over a large area of users from a satellite at a low cost.

While particular embodiments of the present invention have been shown and described, numerous variations and alternate embodiments will occur to those skilled in the art. Accordingly, it is intended that the invention be limited only in terms of the appended claims.

What is claimed is:

1. An electronic communication device for storing and displaying text, said device comprising:
means for storing data;
a microprocessor for manipulating stored data;
a display screen for displaying stored data; and
a telecommunications module for transmitting to or receiving data from a satellite system.

2. The device as claimed in claim 1 further comprising means for transmitting a request to said satellite system for data to be received by said device.

3. The device as claimed in claim 1 wherein said satellite system further comprises a control and uplink station for communication with said satellite system.

4. The device as claimed in claim 3 wherein said satellite system further comprises:
at least one satellite;
a primary control station for tracking and controlling said satellite;
a secondary control station for transmitting data to said satellite;
whereby said electronic storage and display device receives data from said satellite.

5. The device as claimed in claim 3 wherein said satellite system further comprises a constellation of satellites providing global coverage.

6. The device as claimed in claim 1 wherein said device is an electronic book.

7. The device as claimed in claim 6 wherein said electronic book is a textbook.

8. The device as claimed in claim 1 wherein said device is an electronic billboard.

9. A method for updating an electronic storage device comprising the steps of:
sending text from a ground station to a satellite system;
transmitting said text from said satellite system to an electronic storage and display device; and
receiving said transmitted text at said electronic storage device.

10. The method as claimed in claim 9 further comprising the step of requesting text from said satellite system for receipt by said electronic storage and display device using said electronic storage display device.

11. The method as claimed in claim 9 wherein said step of receiving said transmitted text further comprises receiving said transmitted text at very low data rates.
